(19) United States
(12) Patent Application Publication
(10) Pub. No.: US 2002/0169777 A1
(43) Pub. Date: Nov. 14, 2002

(54) Database architecture and method

(76) Inventors: Liviu Balajel, Laguna Niguel, CA (US); David Rager, Newport Beach, CA (US)

Correspondence Address: Karl M. Steins, Steins & Associates, Suite 120, 2333 Camino del Rio South, San Diego, CA, 92108, US

(21) Appl. No.: 09/810,756

(22) Filed: Mar. 15, 2001

(51) Int. Cl. G06F 7/00

(52) U.S. Cl. 707/10

(57) ABSTRACT

An Improved Database Architecture and Method is disclosed. Also disclosed is. The system has three subsystems, namely, a master data system, at least one local data system and a communications system for permitting the local data systems to communicate with the master data system, wherein the method for exchanging information between the local and master data system is in the form of data record messages. The local and master data systems each include data repositories defined by a database records; each database record has content data, relationship data and edit history data. The data record messages have content that is in one or more of several standard generalized mark-up languages, where this content is in a highly formatted structure, and is defined by content data, relationship data and edit history data, such that a “database update” is the act of applying each data record message to update the corresponding data record, or alternatively, adding new data records that duplicate the data record message.

### BACKGROUND OF THE INVENTION

1. Field of the Invention

This invention relates generally to computer database systems and, more specifically, to an Improved Database Architecture and Method.

2. Description of Related Art

When searching for a software product to utilize for managing the business process of contacting sales prospects, identifying leads, issuing proposals, preparing internal sales forecasts, preparing vendor sales forecasts, issuing internal sales orders (bookings), issuing purchase orders, issuing invoices, tracking accounts receivable, collecting financial information and payment history for future payment terms, logging customer products, tracking customer support, managing vendor pricing information, managing sales quotas and performance, administering sales commission schedules, the inventors discovered that there were no software products in the market that would address a business in its entirety. Instead, there are products that address specific problems. When used, each becomes an island of productivity in a corporate structure.

In particular, if a user desired to create a comprehensive business system by assembling the available specialized software productivity products, such as contact management, sales automation, customer relationship management, manufacturing resource planning, accounting, etc., they would be required to integrate disparate and incompatible software. The resultant “package” would result in a cumbersome, complex and manually driven method of sharing data between the software systems (not to mention the further need for a large amount of commercial support software and hardware). Such an effort would be technically challenging if not impossible, due to the proprietary nature of conventional databases. Add to this the difficulty of using such a system effectively from remote offices and by mobile workers, and the cost of development and maintenance of such a system becomes prohibitive for a small to medium-sized business. As a result, especially in small businesses, powerful and expensive computers are being used for little more than productive word processors and spreadsheet calculators, things that could be done quite well with Intel 8086-based computers running a CPM or DOS operating system.

Consequently, there are very few integrated information systems in use that offer a comprehensive approach to a business as a whole. The ones that are considered the most integrated are either extremely general (Microsoft Office) or extremely specific (a national fast food franchise Point of Sale/Inventory Management/Store Reporting system). Consider Microsoft Office. It contains a document editor (MS Word), a spreadsheet application (MS Excel), database support (MS Access), a presentation tool (MS PowerPoint) and a mail-client/personal information manager application (MS Outlook). However, because the types of data managed by each application are different (e.g. text data in MS Word, numeric data in Excel and graphics data in PowerPoint), these products can not intelligently deal with data originating from another program in the Office package. Data can be displayed, but if it is to be changed, the best one can do is invoke the other application to manipulate it within its native environment.

At the other extreme is a specific system like the fast food franchise, that was developed specifically for that corporation and utilizes data that is extremely proprietary and cannot be utilized by other applications without developing specific software to do so.

Many applications are introduced each year that address a very narrow aspect of a company's business. For example, Contact Management, Sales Automation, and Accounting are areas separately targeted by software manufacturers. Whenever any of them are expanded to address other areas of need, such as a contact manager being expanded into sales automation, the resulting software product is severely limited because the new task is forced to work with data structures that were developed for a different purpose. Furthermore, they have native data formats that are proprietary and force the user to interface with them through interfaces or external data files, rather than allowing direct access to the data.

That the industry consists of software developed to address narrowly-defined, specialized tasks is easy to understand. In the past, complex computer languages, specialized data structures, operating system limitations, communications restrictions, computer resource limitations and application knowledge forced companies and software development firms to develop narrowly-focused products. However, the result is a company environment where employees must use several different software programs to do different tasks, all of which should be interrelated in performing the company's business. Each product has a different user interface, terminology, style and “feel”, and most times it is difficult to utilize common data from one application in another. This leads to a loss in productivity and the introduction of errors resulting from the continuous re-entry of data between these “islands of automation”.

If we turn to FIG. 1, we can explore the physical limitations of a current database design. FIG. 1 depicts a conventional Client-Server Distributed Database System 10. As can be seen, the conventional system 10 comprises a Data Manager Application 12A in communication with one or more Client Terminals 14, typically by some type of Network Conduit 16 (e.g. the World-wide Web or a Local Area Network). It is customary that the client terminals 14 are “thin” (essentially “dumb” terminals) in this Client-Server structure. Each terminal 14 has a client interface 18 for displaying and modifying data to the user. It should be understood that the Data Manager 12A is a software and hardware device for sharing data housed within a Database 20 with one or more terminals 14. With respect to access to the database 20, the client terminals 14 are subordinate to, and essentially controlled by the data manager 12A.

There are several problems with this structural design, namely, all of the client terminals 14 must be connected to the data manager 12A in order to have access to the database 20; in the case of a www-based database system, this can be very undesirable. Under this database system structure, and as will be discussed further below in connection with FIGS. 3 and 4, it is extremely difficult to modify the basic structure of the database 20, once it has begun to be populated with data. Furthermore, this conventional client-server design is very slow—the need for constant network conduit 16 connection makes the response of the system very communications-quality-dependent; because of the nature of the database 20 data storage design, there is a tendency to force extensive communication between the terminals 14 and the data manger 12A, further exacerbating the communications environment; still further, in this client-server design, the data manager 12A will typically only permit single user access to any one data record in the database 20 at any one time in order to preserve the data integrity under this archaic design.

Turning to FIG. 2, we can examine another attempt in the art at solving some of the aforementioned problems. FIG. 2 depicts a conventional Synchronized Distributed Database System 22. This design is particularly prevalent for Database Systems distributed over wide-area networks, such as the www. In this prior design, the terminals 15 are of the “thick” variety (e.g. Personal Computers), and as such, have substantial processing power. As such, under this system 22, the client terminals 15 have their own Local Data Managers 13 for communicating with the main Data Manager 12B, as well as managing an individual Local Database Copy 21. It is common under this design for each terminal 15 to operate independently from the Data Manager 12B and Central Database 20, with all updates being applied only to that terminal's 15 local database copy 21. Daily (or on another schedule), each local database copy 21 is synchronized with the central database 20 (usually during periods of inactivity at the terminals 15). As each terminal 15 synchronizes, the central database 20 is updated with that particular local database copy's 21 information, while at the same time the local database copy 21 is being updated with any updates received by the central database 20 from other terminals 15.

There are several problems with this design also, namely the large amount of data representing the entire local database that must be transmitted both from the local database copy to the data manager and from the data manager back to the local database copy, and the intrinsic delay or aging of the data at each local database copy 21. Depending upon the periodicity of the synchronizations, the data could be very stale. Also, depending on the number of updates, these synchronizations could require a substantial amount of time to conduct—as activity (and number of network nodes) increases, the duration of these synchronizations will also increase. Still further, and as with the design of FIG. 1, the conventional database 20 is structured such that it is extremely difficult to change the structure of the database 20 (or the local copies 21) once they are populated with data.

As discussed above, we will now examine the defects in the structure of the database, itself. FIG. 3 depicts a conventional Relational Database Structure. In the conventional design, the database comprises a Main Table 24 that is comprised of rows of Database Data Records 26 made up of Data Fields 28. Fields 28 are linked (or related to) a Sub-Table 30A-30C within which the optional data to be used in the Records 26 is stored. We shall now review a specific example of a conventional Relational Database, as provided in FIG. 4.

FIG. 4 depicts example relational tables of the Structure of FIG. 3 populated with actual data. In this example the main table 24 is filled with resume information for candidates seeking employment. As can be seen, the fields 28 (see FIG. 3) include “Res_ID” or the identification of the particular resume; “Name,” or the candidate's name; “Skill_{—}1” through “Skill_{—}3,” to represent up to three skills that the candidate claims to possess; a “Profile” describing a summary term for the position sought; and “Degree,” for storing the candidate's highest degree held.

Each sub-table 30 stores the information to be used in the data records 26. As can be seen, the Skills Sub-table 3 OA is related to all three “Skill_” fields. As discussed above, the problem with this table design is that only one user can edit the contents of a particular data record 26 at one time. Furthermore, should it be desired that additional fields 28 be added (or that existing ones be modified), not only does the main table 24 and sub-table(s) 30 need to be modified, but so does the client interface 18 (see FIGS. 1 and 2). In fact, the process involved in modifying the client interfaces and database tables can be so labor-intensive that these actions are usually only feasibly done once or twice annually to enable (the necessary) full testing of the new system without risking damage to existing data.

What is needed, therefore, is an improved database structure and method for distributing the contents of a central database to a network of clients that has a flexible structure that can be improved continuously in a real-time manner in all areas: user interface, business logic and database schema, rather than mandating a system-wide maintenance process; is less communications-dependent than prior systems; that uses the full system power at the client site, like a thick client application, but with full involvement by the master database system as in a thin client system; and that is not limited to single-user access to data records.

### SUMMARY OF THE INVENTION

In light of the aforementioned problems associated with the prior systems and methods, it is an object of the present invention to provide an Improved Database Architecture and Method. It is a further object that the system have three subsystems, namely, a master data system, at least one local data system and a communications system for permitting the local data systems to communicate with the master data system, wherein the method for exchanging information between the local and master data system is in the form of data record messages. It is an object that the local and master data systems include data repositories defined by a database records; each database record should have content data, relationship data and edit history data. Consequently, it is a still further object that the data record messages have content that is in one or more of several standard generalized markup languages (conventionally used in wide area networks), where this content is in a highly formatted structure, and is defined by content data, relationship data and edit history data, such that a “database update” is the act of applying each data record message to update the corresponding data record, or alternatively, adding new data records that duplicate the data record message.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 depicts a conventional Client-Server Distributed Database System;

FIG. 2 depicts a conventional Synchronized Distributed Database System;

FIG. 3 depicts a conventional Relational Database Structure;

FIG. 4 depicts example relational tables of the Structure of FIG. 3;

FIG. 5 depicts a preferred embodiment of the Improved Distributed Database System of the present invention;

FIG. 6 depicts a preferred embodiment of the Master Data System of the system of FIG. 5;

FIG. 7 depicts a preferred embodiment of a Database Communications System of the present invention;

FIG. 8 depicts a preferred embodiment of a Local Data System;

FIG. 9 depicts the preferred structure of the Improved Database of the present invention;

FIG. 10 depicts an example of the preferred Content and Relationship Data of an Improved Database Data Record of the present invention;

FIG. 11 depicts a pair of examples of partial database data records of the Improved Database of the present invention;

FIG. 12 depicts a possible effect on existing database data records when an additional database data record is added to the Improved Database of the present invention; and

FIG. 13 depicts a preferred method for the Client Interface and Improved Data Manager to communicate under the system of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide an Improved Database Architecture and Method.

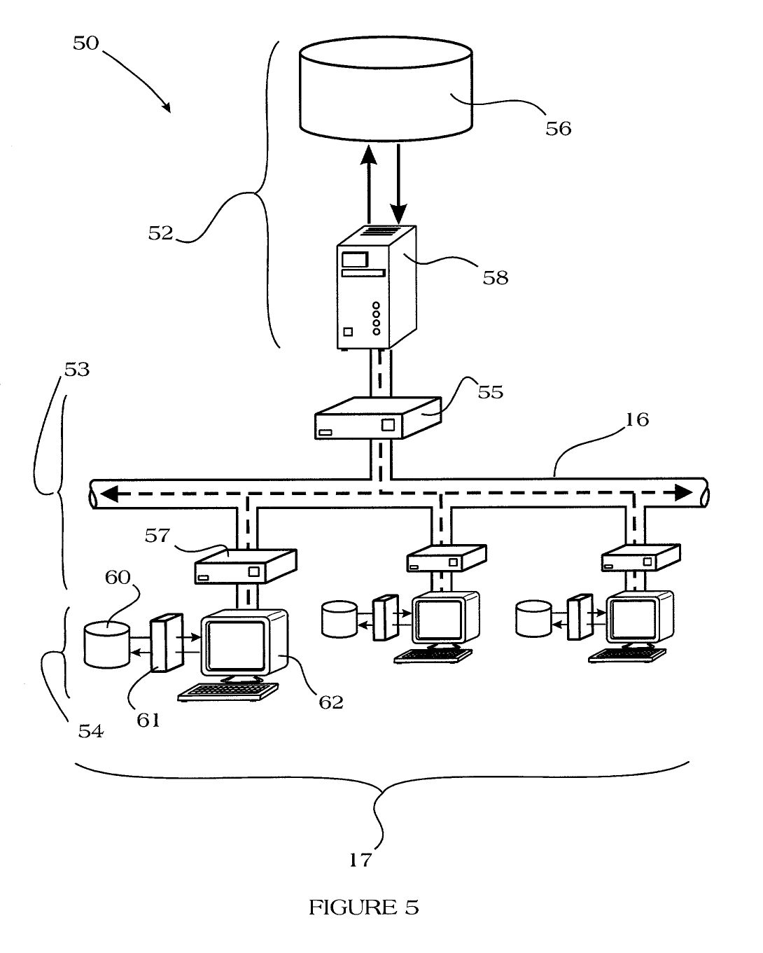

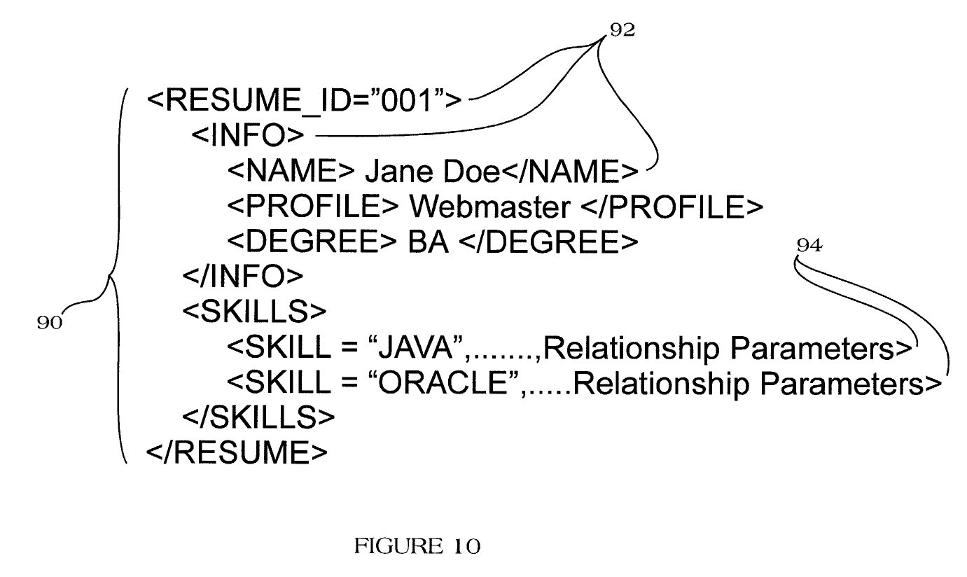

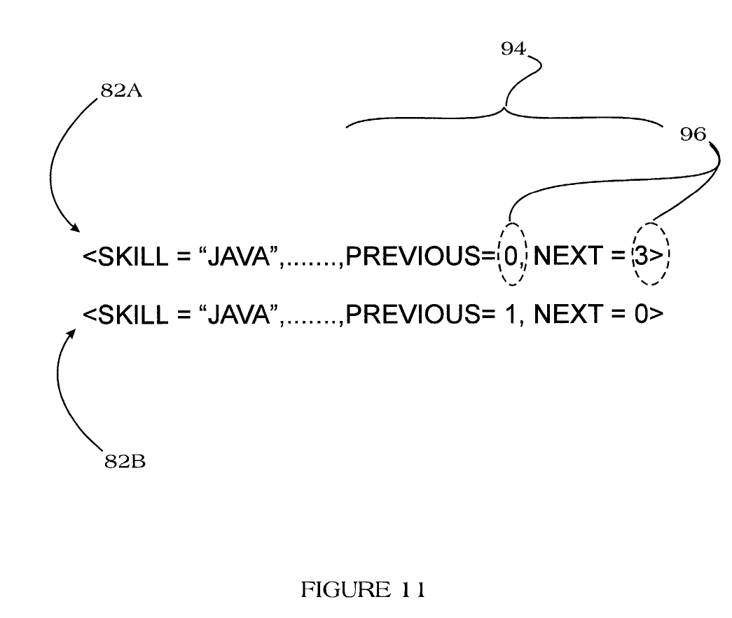

The present invention can best be understood by initial consideration of FIG. 5. FIG. 5 depicts a preferred embodiment of the Improved Distributed Database System 50 of the present invention. The System 50 is essentially comprised of three sub-systems: the Master Data System 52, the Database Communications System 53, and one or more Local Data Systems 54; each Local Data System 54 is in communication with the Master Data System 52 (via the Database Communications System 53) by a variety of arrangements, including a Wide-area Network Conduit 16 shown here; it should be understood that any conventional wired or wireless method for connecting one or more Local Data Systems 54 with the Master Data System 52 might be substituted for the conduit 16 shown. The Master Data System 52 comprises an Improved Master Database 56 and an Improved Master Data Manager 58. The Improved Master Database 56 has a completely unique architecture and functionality that takes advantage of the networking languages and formats available today; further detail will be provided below in connection with FIGS. 10 and 11.

The Improved Master Data Manager 58 is, essentially a software application that manages the shared, flexibly-structured Improved Master Database 56. The Improved Master Data Manager 58 is preferably executed by a Master Server computer, and it's function is to monitor client (computer) requests, and maintain the Improved Master Database 56. Logically, the Improved Master Database 56 is a single entity; physically, however, it can comprise a number of sub-Master Databases, each of which consists of a portion of the overall data and is controlled by a sub-Master Data Manager and corresponding sub-Master Server computer. Each sub-portion of the total data can be moved from one physical computer to another without compromising system integrity. Data mirroring functions are also conducted in a similar manner.

Each Local Data System 54 is very similar to the Master Data System 52, in that they each comprise a Local Database 60, an Improved Communications Manager 57, and an Improved Local Data Manager 61. The Improved Local Database 60 is architecturally and functionally the same as the Improved Master Database 56, differing only in that it represents some subset of the Improved Master Database 56.

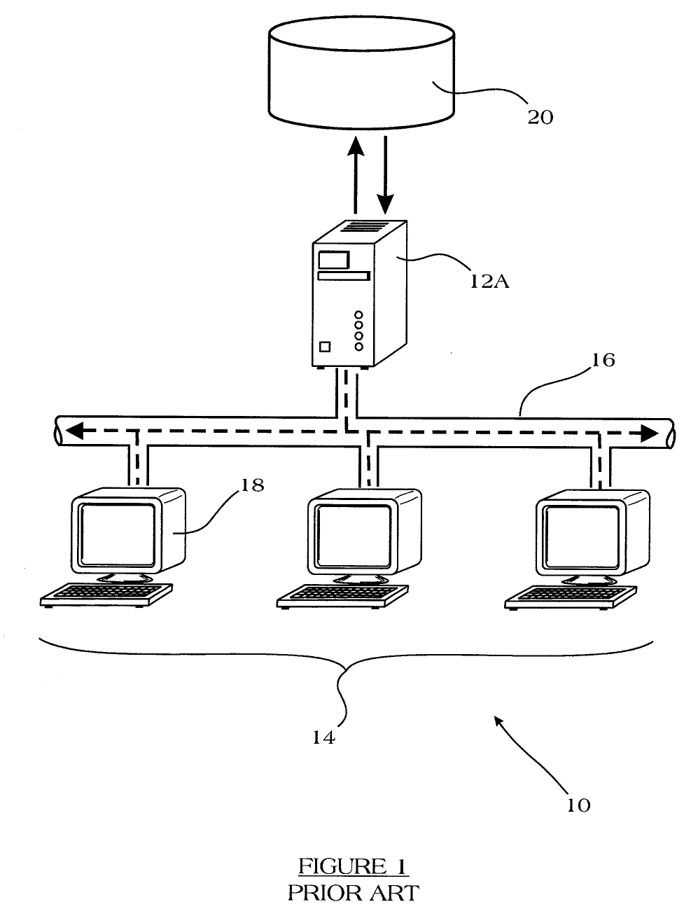

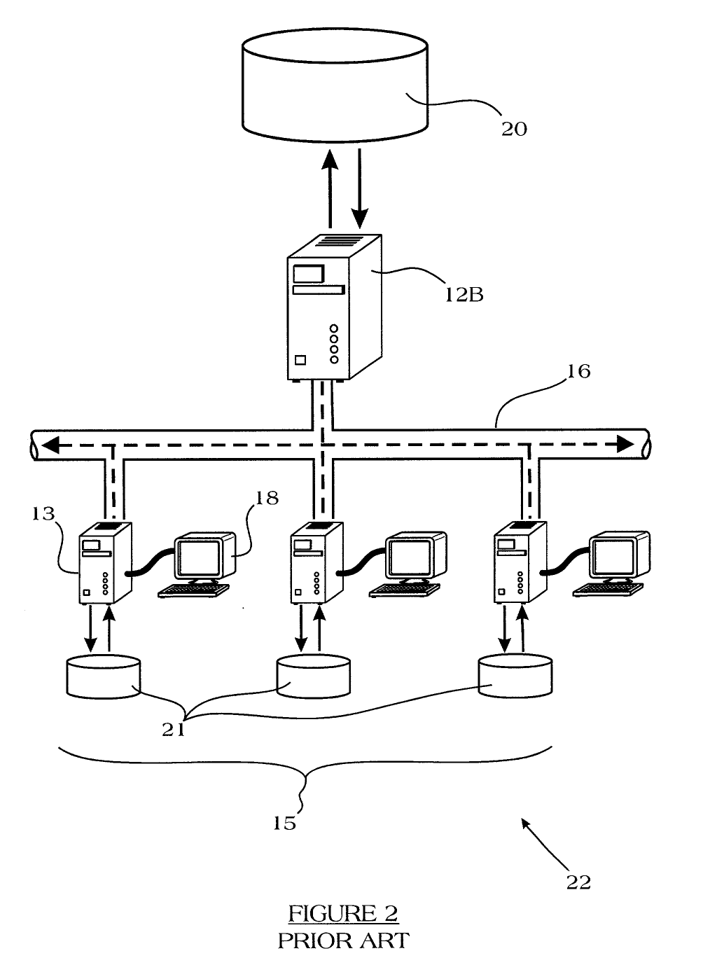

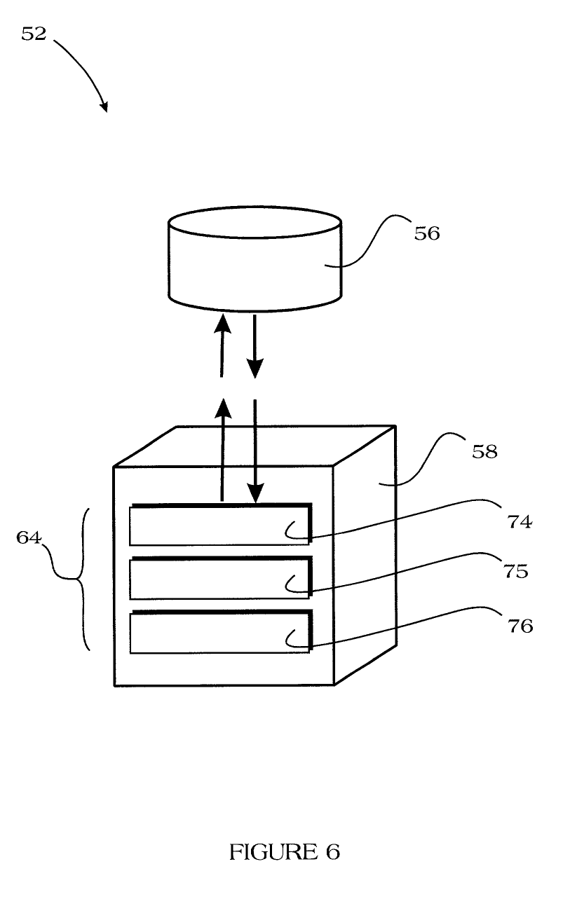

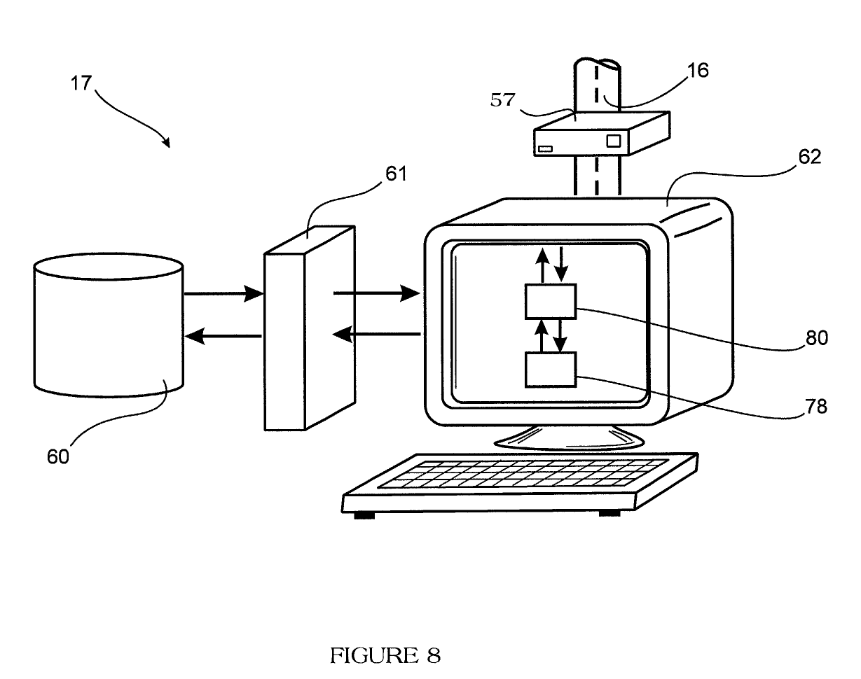

Furthermore, the Local Data Systems 54 typically comprise Client Terminals 17 that are thicker than the “Thin” terminals of FIG. 1, however not necessarily as thick as the “Thick” terminals of FIG. 2. Each terminal 17 comprises an Improved Local Database 60, an Improved Communications Manager 57, and an Improved Client Interface 62. The Improved Client Interface is described more fully below in connection with FIG. 8, but it is generally a software application running on a Personal Computer-scaled computer, that manages the user's interface, along with working with the Local Data System 54 to maintain the Improved Local Database 60. In order to explain further detail regarding the Master Data System 52, we shall now turn to FIG. 6. FIG. 6 depicts a preferred embodiment of the Master Data System 52 of the system of FIG. 5.

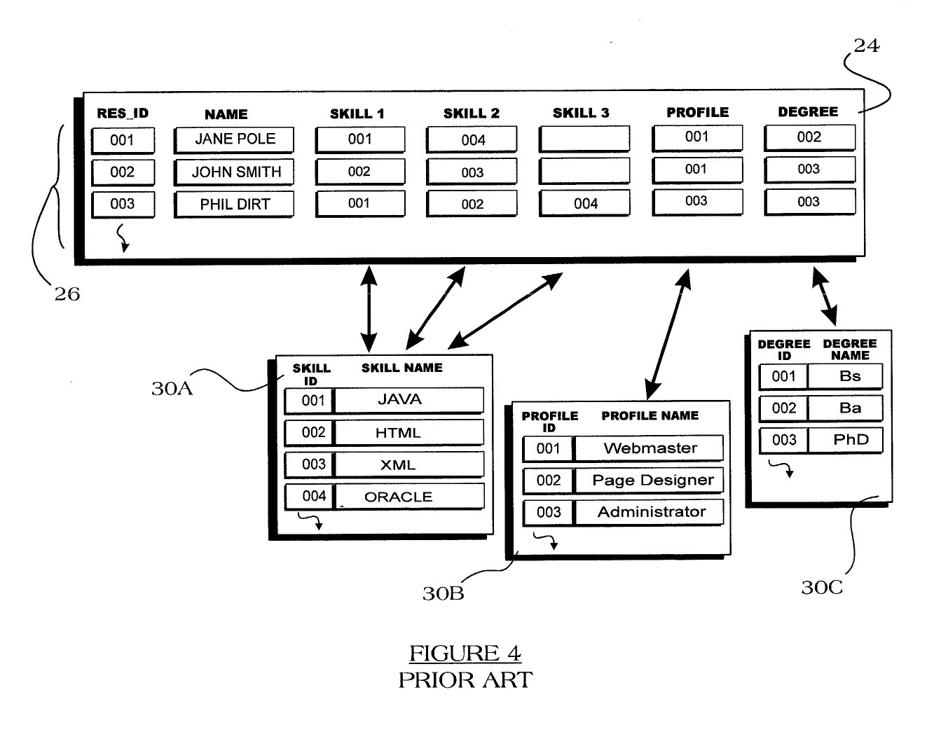

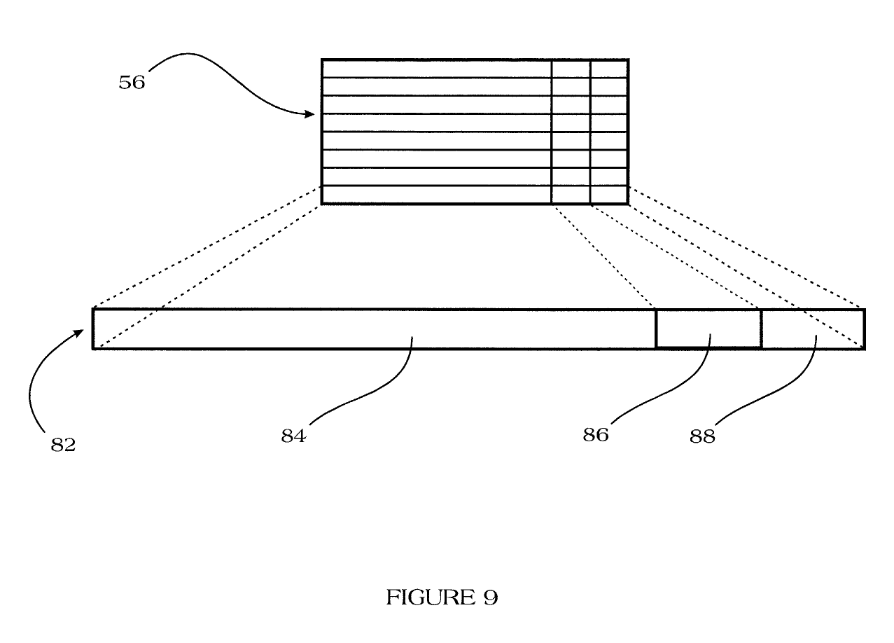

The Master Data System 52 comprises an Improved Master Database 56 and an Improved Master Data Manager 58. In contrast with the index and table structure employed in conventional database systems (see FIG. 4), the Improved Master Database 56 is made up of a “meta collection” of “meta documents” or metadata; in essence, highly organized structures of highly organized documents of highly organized data (see FIGS. 9-12, below).

The Master Server 64 preferably comprises three modules: the Master Database Manager 74, the Security Manager 75, and the Server Logic 76. The Master Database Manager 74 performs database navigation and database updating functions; it also manages the database schema as approved by the Security Manager 75 and the Server Logic 76.

The Security Manager 75 provides user access authorization and verification, data encryption and other data security functions for system use of data contained in the Improved Master Database 56. Notice that the Security Manager 75 can be positioned behind the Server Logic 76. This allows the Master Data System 52 to react to users according to rules that check usage of the Improved Master Database 56 prior to the security check.

The Server Logic 76 provides application-tailored functions related to the use of data from the Improved Master Database 56. These functions include, but are not limited to: data rules checking and enforcement (e.g. form, range) and expert-system-like functions related to, among other functions, processes and searches, queries, related activities, etc.

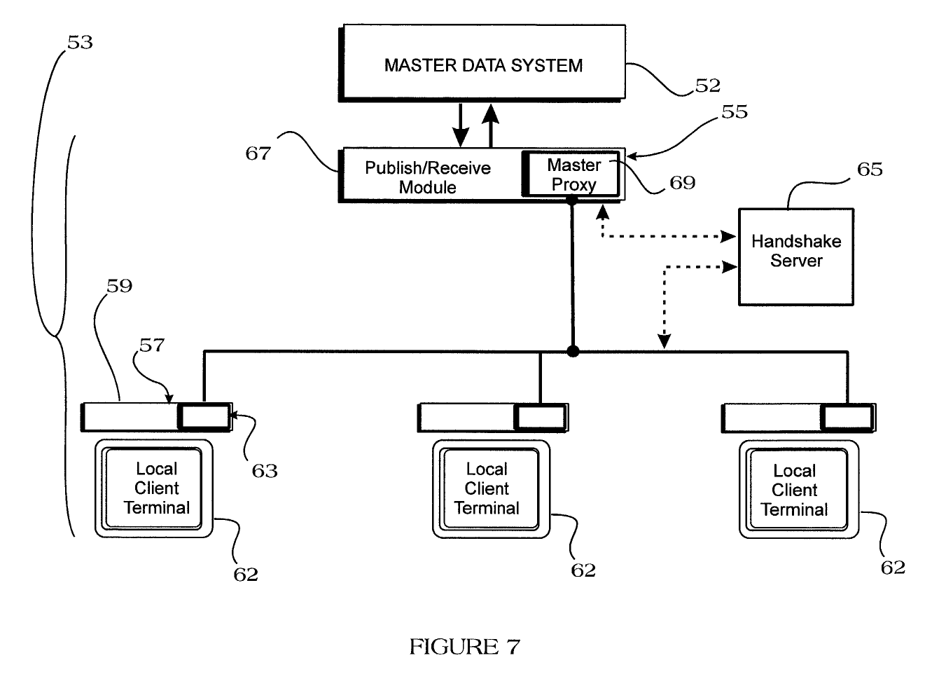

All activity initiated at the Local Data System is communicated to the Master Data System 52 by the Database Communication Management System 53, as depicted below in FIG. 7. As shown in FIG. 7, the Communication Management System 53 handles all the communication involving new or modified client data in “real-time” between the Local Databases and the Master Server Application 64 (see FIG. 6). The System 53 comprises an Improved Master Communications Manager 55, in communication with a plurality of Improved Local Communications Managers 57. Each Improved Local Communications Manager 57 comprises two components: The Local Transmit/Receive Module 59 and the Client Proxy 63.

The Local Transmit/Receive Module 59 acquires “messages” relating to database changes in the Improved Local Database 60 from the Improved Local Data Manager 61 (see FIG. 5), whereafter it packages them, buffers them, and then delivers them to the Client Proxy 63 for transmission to the Improved Master Communications Manager 55. The Client Proxy 63 checks for interconnectivity, and if it finds that the Local Client Terminal 62 is connected to the Master Data System 52 by any means, it will initiate communication with it. If there is no connection, the Client Proxy 63 may seek an alternate means of connection by use of the Handshake Server 65. Failing both of these attempts, it will initiate an “off-line” session until communication with the Improved Master Communications Manager 55 can be established.

The Improved Master Communications Manager also comprises two components: the Publish/Receive Module 67 and the Master Proxy 69. The Publish/Receive Module 67 acquires “messages” relating to database changes in the Improved Master Database 56, then packages them, buffers them, identifies all of the Local Data Systems 54 that are contained in (or affected by a) message, and delivers them to the Master Proxy 69 for delivery to all “interested” Local Data Systems 54. The Master Proxy 69, of course, also receives change messages from the Local Data Systems 54 (see FIG. 5), and buffers and delivers them to the Master Data System 52 for updating of the Improved Master Database 56. In operation, the system considers “real-time” to be “as-soon-as-possible”. If a client is forced to work off-line, or the communications or computer systems are temporarily unavailable, it will collect new or modified client data and communicate it to the Improved Master-Database 56 (via the Master Server 64) as soon as it becomes available (see FIG. 5).

The Handshake Server 65 in the Communication Management System 53 manages the location of each Local Data System as well as any Master Data sub-System by automatically managing IP addresses for both. This eliminates the need for the user to become involved in computer details in order to communicate with the Improved Master DataSystem 52. The Handshake Server 65 also automatically supplies authorized software upgrades, installs them, provides on-line maintenance and debugging support, and performs other functions necessary to assure system integrity without the need for human interaction. Further, it manages alternative addresses for system resources and provides functionality when necessary due to limitations with ISP's such as the lack of full support for HTTP or PTP transfer protocols. The Client Proxy 63 offers a TCP/IP connection to the Improved Master Data System 52 and assures the transport of data to/from the Improved Master Data System 52 in collaboration with the Master Proxy 69. The Master Proxy 69 continuously monitors client-requests and forwards them to the Master Server 64 and sends resolved requests from the Master Server 64 back to the Local Data System(s) 54 that are affected (see FIG. 6).

Now turning to FIG. 8, we can examine the preferred Local Data System 54 (see FIG. 5) in further detail. As seen in FIG. 8, each Terminal 17 comprises an Improved Client Interface 62 and a Improved Local Database 60, which may contain all or only a portion of the Improved Master Database. As discussed previously, the preferred terminal 17 is the desktop computer having average computing power; this device could also be a laptop computer, Personal Information Manager device, etc. Within the Improved Client Interface 62 are found two modules: the Client Graphical User Interface 78, and the Client Logic 80. The Improved Client Interface 62 is an application executable on the terminal 17, and serves to display the Improved Local Database information and interested group news A unique feature of the Improved Client Interface 62 is that it automatically reflects structural changes to the database without the necessity for any changes to be made to the programming code of the Improved Client Interface 62.

The Client Logic 80 carries out Client functions and the Client Graphical User Interface 78 includes a set of Client-side application customization tools. The principal customization tool is a subset of the DTD Editor that will allow the user, within the boundaries of permissions granted to the Client, to change or extend data managed in his Improved Local Database 60 of data, the Master-Data database and the physical arrangement and display of data. It should be understood that the Improved Local Database 60 contents will be determined by the permissives and access assigned to the particular user of Terminal 17; it is envisioned that many users will only be permitted to work with very targeted portions of all of the total data being managed by the System 50 (see FIG. 5).

Furthermore, regardless of how the user is connected, whether directly or via a local area network, dial-in line or Internet connection, the underlying protocol is the—TCP/IP. Using technology not unlike that used by cellular telephone systems, the Communication Managment System 53 assures communication independence for the system, eliminating the need to develop different forms of response to users based on connectivity. The Communication Managment System 53 works naturally with direct connections, wireless connections, wireless networks, Local Area and Wide Area Networks (LANs and WANs), dedicated connections, Internet, Intranet and Extranet systems. Because it achieves this independence from the communications-infrastructure without requiring any external communications modules, code converters, the Improved System 50 is referred to as being “network natural”.

Now that the communications and control structure of the present invention have been explained, we shall embark on the disclosure of the unique structure employed to fully achieve the design goals of the invention. FIG. 9 depicts the preferred structure of the Improved Master Database 56 of the present invention. Of course, it should be understood that the Local Database Copies follow the identical structural rules as does the Master Database 56.

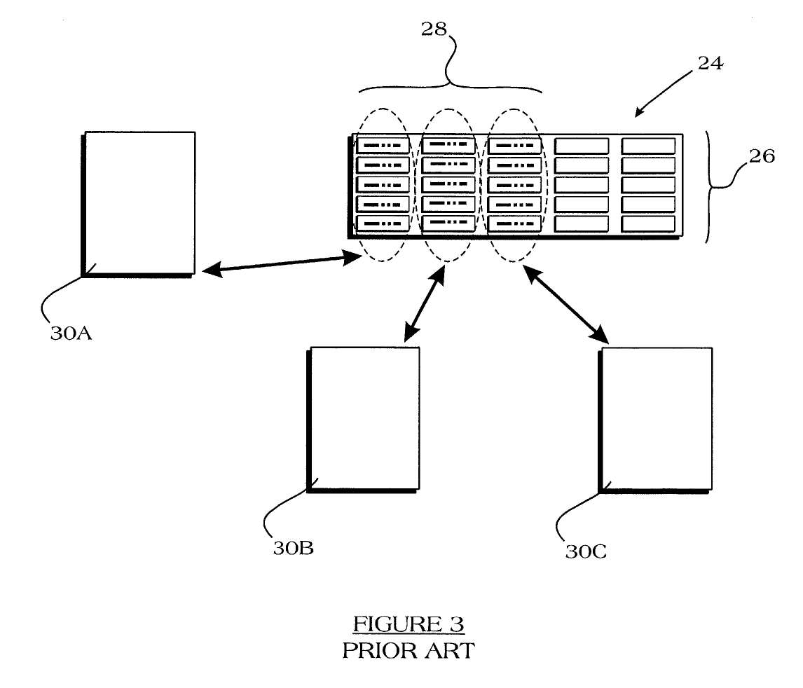

Unlike the conventional related table design depicted above in FIGS. 3 and 4, the preferred embodiment of the Master Database 56 of the present invention is simply comprised of individual Data Records 82 that are constructed in a highly structured format, and scripted in a standard generalized markup computer language (e.g. XML). Each Data Record 82 is defined by many data sections. In this minor illustration, we will consider only three major data sections: the Content Data Section 84, the Relationship Data Section 86, and the Edit History Data Section 88.

The Content Data Section 84, is more fully described below, but essentially contains all of the content that is pertinent to the subject of a particular Data Record 82 (e.g. for an individual's resume). The Relationship Data Section 86 includes information that orients one Data Record 82 to other Data Records 82 within the Improved Database 56, such that very rapid database searches can be conducted. The Edit History Data Section 88 includes the history of any actual or requested changes to a particular Data Record 82, for the purposes of control by the Master Data System 52 (see FIG. 5).

If we now turn to FIG. 10, we can examine an example of the resume database of FIGS. 3 and 4 as it might exist within the Database of the present invention. FIG. 10 depicts an example of the preferred Content and Relationship Data of an Improved Database Data Record 52 of the present invention. As can be seen, the Content and Relationship Data 90 of a particular Data Record 82 is constructed of a series of field identifiers known as MetaTags 92 surrounding or otherwise flagging Content Data. In this example, the content and relationship data 90 for resume 001 (for “Jane Doe”) would include as many fields as desired such that a full description is made. In particular, note that the same Name, Profile and Degree data is simply held between a pair of MetaTags 92. Should any user desire to add additional “fields,” they need only add it to their Improved Local Database; the result would be a new set of MetaTags 92 specific to that new field, along with the pertinent Content Data. It should be casually apparent that under this configuration, the Database structure is eminently flexible because the prior relational table setup has been eliminated; other benefits will be discussed below.

As to the “skills” information, it can be seen that between the “skills” MetaTags 92, a simple list of different skills (along with relationship parameters 94, if appropriate) will be developed. The power of these Relationship Parameters 94 are discussed below in connection with FIGS. 10 and 11.

It should be understood that this database structure is transparent to the user; the Improved Client Interface 62 (see FIG. 7), and more specifically, the Client Graphical User Interface 78 (see FIG. 8) are configured to permit the user to view the data by conventional “windows” presentation. Furthermore, where data is to be imported or exported to external applications, it is a simple matter of a report generated by a database query that provides only content data.

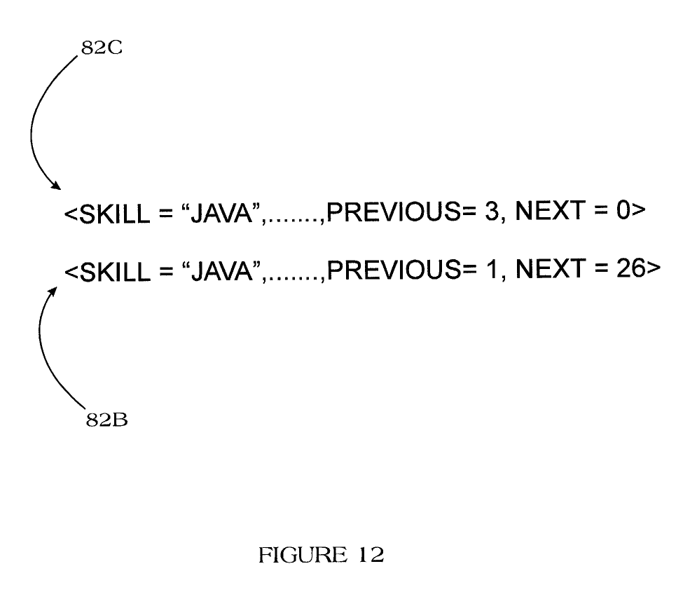

Now turning to FIG. 11, we can examine the functionality provided by the Relationship Parameters 94. FIG. 11 depicts a pair of examples of partial database data records 82A and 82B of the hnproved Database 56 of the present invention. The partial record 82A is one of the skills for “Jane Doe;” as can be seen, this skill is “Java.” In order to expedite future searches for all persons having Java as a skill in their resume, the Relationship Parameters 94 will include the Record ID Numbers 96 for the “previous” data record having the Java skill, as well as the “next” data record 82 having the Java skill. If we assume that “Phil Dirt” is the “next” record 82, we can see that Jane Doe's partial record 82A identifies Phil Dirt's record 82 as being the “next” record where Java is a skill. If we assume that Phil Dirt's record 82 is the “last” record including Java as a skill, we can see that the “next” record ID=“0” (meaning that it is the last record 82 with a Java skill). In this way, all records 82 including the Java skill are linked to one another, thereby accelerating any search for this term. In fact, tests prove that under this structure, search routines performed on large databases of the improved design are much faster than under conventional structures. The case of a new record 82 having a Java skill in it being added to the database 56 is discussed below in FIG. 12.

FIG. 12 depicts a possible effect on existing database data records when an additional database data record 82 is added to the Improved Database 56 of the present invention. In this case, the record 82 (and therefore the partial record 82C) has an ID number of 26. When added, it is a simple matter for the Client Data Manager 76 to detect that “Phil Dirt” was the “last” data record 82 having the Java skill (ID=3). Once detecting this, the Manager 76 places this ID (i.e. 3) into the new record's “previous Java” Parameter 94, while also updating Phil Dirt's partial record 82B to indicate that the record 82 (and therefore the partial record 82C) is the “next Java” from Phil Dirt's record's perspective.

The non-obvious benefit of this new method for editing the database is that when this (e.g. add record) transaction is completed, only two data records 82 are updated in the Master Database 56 (see FIG. 5). Since only two records 82 have been changed, only these two records 82 are transmitted to the Master Data System 52 (see FIG. 5), thereby substantially reducing the communications burden. This means that database updates can be done in “little pieces” on an ongoing basis (or whenever is convenient for the System 50).

Furthermore, since each user is operating from their own Improved Local Database 60 (which is update immediately upon editing), the benefit provided by the synchronized system of FIG. 2 is obtained, including the ability for users to make changes to the “database” simultaneously. The difference here is that since the size of the database updates is very small, the data aging problem is virtually eliminated.

This unique database utilizes documents (collections of data entities) of metadata that define data, structure, content, peer relationships, extra-peer relationships and behaviors (including, but not limited to change-related activities and change impact assessments) and dynamic interface effects. These highly organized documents include a variety of structural definitions and transformation templates that define the data entities in the document.

The highly organized collection of documents provides the description, or schema of the database. These collections may be structured as elements in a super-collection of collections, providing hierarchical database definitions.

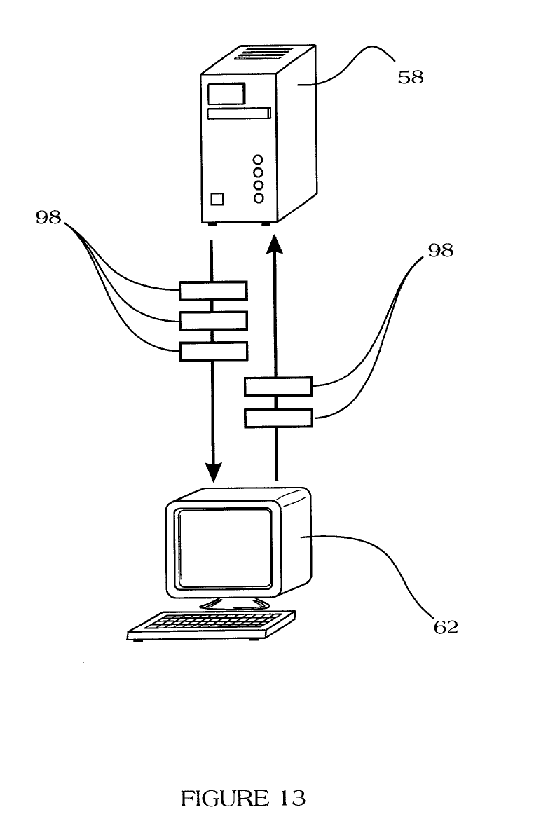

As shown in FIG. 13, the Improved Data Manager 58 and the Improved Client Interface 62 update one another's Databases by exchanging small Data Record Messages 98, which are, essentially updated Data Records 82, including any control parameters or other information generated by the Data Manager 58. Major structural changes can be accomplished in the database(s) by simply adding one or more data sections. Such changes would automatically be reflected in the Graphical User Interface.

While the preceding example reflects a very simply application of a subset of the tools and techniques that are employed in the system and method of the present invention, it should be understood that complexity and power are derived from extensions to the basic linking idea presented in this example, and from additional innovation incorporated throughout the System. For example, rather than the simple linking described above, in that the data making up a conventional resume is organized in a document and consists of many data entities, with many classes of data (e.g. contact information, education, work experience, etc.). Each data entity in each data class in a document may be linked internally at a peer level, as well as externally at an extra-peer level with other types of data and processes. Thus, the linking schema for the data in a document can resemble a complex multidimensional “web” of linkages. Other technology incorporated into the system of the present invention can be described in terms of three categories of innovation: Conceptual Innovations; Analytical Innovations; and Technical Innovations.

The principal Conceptual Innovations involved herein are: a System Markup Language that is used to describe a system and its subsystems; a Database Markup Language that is used to describe the database schema; a Database Query Markup Language that is used to define querying, searching and analytical processes, expert-system-like capabilities, bridges to outside data sources including other non-XML databases and to interpret plain language or standard types of data queries (such as SQL queries); and a Database Scripting Markup Language used to define processes and activities involving the database and to determine the conditions under which such processes or activities should be automatically carried out. These languages are all based on the standard generalized mark-up language (SGML) specification.

The principal Analytical Innovations are as follows: the automatic management and display in a “Table of Contents” form, with any number of parallel Table of Contents views of the database structures; data perusal in the form of roaming the database, skimming the database and sampling the database; full text search support as a native capability of an XML database; Dynamic, N-Dimensional analysis and search and support as a native capability of an XML database; asynchronous search capability that lets a user start viewing and working with initial search results while a search or query process is being conducted; amorphous database structure, where data collected in various XML databases in various physical or logical locations can be treated as a single database; data viewers that allow users to veiw data contained in an XML database without requiring database software; database objects identified as documents or pamphlets that are highly organized through parsing, analysis, modeling, processing, highlighting, linking, extending and/or transforming; and an XML database connectivity that links an XML database to external sources of data, or even non-XML databases.

The principal Technical Innovations used to implement the present invention are: internal, embedded, multidirectional links used for peer relationships of data entities; external linked lists for navigation and searches; flag maps used for extra-peer relationships of data entities; structural dictionaries that identify data entities along with their synonyms, antonyms, thesaurus references, equivalencies, slang equivalents, jargon equivalents, correspondences, etc.; associative dictionaries that combine data entities with classes; dynamic multidimensional mapping that positions data in a multidimensional space defined by complex axes comprising unordered sets of data; a handshake server used to provide client/master database interconnectivity; non-contiguous (dispersed) database interconnectivity, software deployment, software module maintenance, updating and troubleshooting; and a general purpose data structuring engine used for organizing, structuring, visually modeling, linking and mapping data in an XML database.

The following Index of Terminology provides further detail about the technical specifics involved in the example of the preferred embodiment of the present invention provided herein. It should be understood that the extensive detail provided in connection with this example (including the tradenames of each generic component) are shown to give the reader a tangible example; in other embodiments or applications, much of this nomenclature could be different.

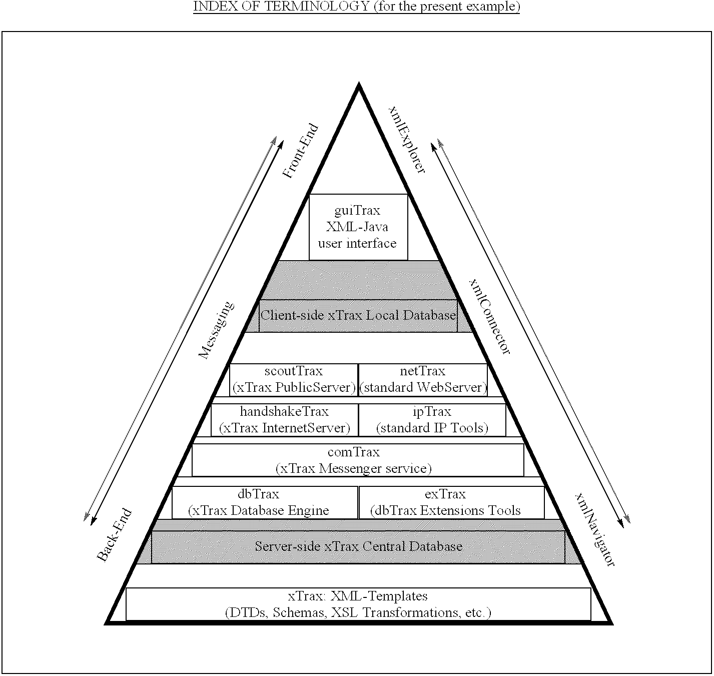

As depicted in the above diagram, the “xTrax” architecture (the database artchitecture for this embodiment of the Improved Database System) can be viewed as a pyramidal structure. At the top level is a powerful but friendly graphic user interface. The foundation is a complex, powerful set of combined XML templates used in a proprietary manner but in complete conformance with XML and other OIM (Open Information Management) standards. These XML templates, in combination with the XML metadata files and elements, are managed by the xTrax Database Engine to provide an extremely powerful, extensible, flexible database system that can be easily modified both in content and in structure. These three blocks of the foundation, xTrax XML Templates, xTrax Central Database and xTrax Database Engine comprise the xTrax Database.

xTrax was developed in response to the primary goal of providing developers with a powerful database development system that results in programs that have native flexibility, allows users to continuously improve the quality of their informational system without costly and time-consuming efforts.

The xTrax Database is algorithmically complex in concept and encoding. Typical database systems use simple, relational back-end databases completed by extremely complex business logic and interface layers. In contrast, xTrax uses elaborate metadata back-ends accessed by simple, standardized user interfaces that continuously and automatically mirror changes in data structures as well as content. Using this approach data collected in xTrax databases is validated by restrictive algorithms and metamorphosed into much richer data with data-content encapsulated by behavioral characteristics and business logic. Data-sets organized in such a manner need only a few standardized tools to be managed. Major changes to the data are reduced to remodeling its data architecture using simple dedicated software modules capable of modeling the whole system through a straightforward, visual interface.

xTrax has been designed as a set of integrated software packages, but each has been structured to allow use as fully-independent entities. Each package has completely modularized architecture, supporting all its tasks internally, without cross-module dependencies. The following table provides a brief description of each xTrax Database System module shown in the diagram on page 25 (above), starting from the base.

TABLE I

| Name | Function | Overview |
|---|---|---|
| Xtrax | XML- | A combined set of DTDs, Schemas, XSLT |
| | Templates | specifications, and other XML-based specifica- |
| | | tions, that form the basic metadata language for |
| | | data's content, behavior, relationships, automated- |
| | | processing, data-roles, transformations, etc. This |
| | | is the xTrax foundation for managing organized |
| | | collections of metadata and for its own control. |
| | Central | The collection of metadata files that comprise the |
| | Database | database being managed for an application and |
| | | located on a central database server. |
| DbTrax | XML | dbTrax performs control-management of the |
| | Database- | entire xTrax system. It supervises all metadata |
| | Engine | management and initiates all automated tasks for |
| | | data parsing, validating, mapping, linking, |
| | | storing, smart-processing, navigating and |
| | | interface-bounding. It also supervises and |
| | | arbitrates multiuser access to the central database, |
| | | monitors client on-off line status and synchronizes |
| | | local and central database repositories. It also |
| | | includes visual tools for system modeling, ad- |
| | | ministration, user-profiling and interface control |
| | | through generic data-events. |
| ExTrax | Database | This package comprises a set of independent |
| | Extension | modules defined as wrappers around dbTrax, |
| | Tools | providing various functions, from standard |
| | | modules for data connectivity to special modules |
| | | for exploitning the XML-based nature of the |
| | | xTrax back-end, such as dynamic-publishing |
| | | for WEB and B2C/B2B eCommerce. |
| ComTrax | Messenger | comTrax consists of a set of modules that provide |
| | Services | the most cost-effective physical link between |
| | | local and central data repositories for |
| | | communicating by an XML-based messaging |
| | | infrastructure. This package focuses primarily |
| | | on offering inexpensive Internet asynchronous |
| | | client-server connections. It also performs |
| | | proprietary encryption algorithms and traffic |
| | | fine-tuning. |
| Hand- | xTrax | This package is a thin Internet Server offering |
| shakeTrax | Internet | specific support to comTrax and XML-based |
| | Server | database extensions. ScoutTrax (see below) uses |
| | | this package to perform networked xTrax |
| | | maintenance, updating and troubleshooting. |
| IpTrax | Standard | IpTrax comprises a standard set of WEB-related |
| | IP Tools | tools that offer an alternative to handshakeTrax. |
| | | This works with any standard WEB-server, |
| | | usually via most common high-level Internet |
| | | Protocols: HTTP, FTP, SMTP, POP, etc. |
| ScoutTrax | xTrax | This is a very special package operating on a |
| | Public | public Internet server. Its primary functions are |
| | Server | the deployment and maintenance of xTrax soft- |
| | | ware through various xTrax virtual networks. |
| | | Another function is to arbitrate typical XML- |
| | | based relationships between different networks. |
| | | It also provides special public services offered by |
| | | MetaSoft, such as various Application Servers |
| | | and B2B and B2C services. |
| InetTrax | Standard | This software package comprises a set of |
| | WEB | wrappers around regular Internet servers, pro- |
| | Tools | viding xTrax compatibility with standard Internet |
| | | software. |
| | Local | The collection of metadata files that |
| | Database | comprise the database being managed by a |
| | | specific user for an application and located |
| | | on a users computer. |
| GuiTrax | Dynamic | The user graphic user interface an explorer, |
| | GUI | browser and a data types registry and fully |
| | | exploits the xTrax XML-specifications in order |
| | | to serialize on-the-fly various Java interface |
| | | objects, based on their XML-footprints. It auto- |
| | | matically mirrors the current database structure |
| | | and content. |

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An Improved Distributed Database System, comprising:
a master data system comprising a master database; and
at least one local data system comprising an Improved Local Database, said local data system including means for communicating with said master data system to exchange data record messages therewith to modify said master database or said improved local database.

2. The System of claim 1, wherein said communicating means comprises at least one master communications manager in communication with at least one local communications manager.

3. The System of claim 2, wherein said master communications managers and said local communications managers are configured to exchange said data record messages where said data record messages comprise system markup language, database markup language, database query markup language, and/or database scripting markup language.

4. The System of claim 1, wherein said master data system further comprises:
a master data manager; and
a master communications manager.

5. The System of claim 4, wherein at least one said master communications manager is configured to communicate with at least one said local communications manager over a wide-area computer network conduit.

6. The System of claim 5, wherein said master data system further comprises a master server, said master server comprising a programmable computer means for executing a database manager application, a security manager application, and a server logic application.

7. The System of claim 3, wherein said master data system further comprises:
a master data manager; and
a master communications manager.

8. An improved method for updating a master database, comprising the steps of:
receiving proposed master database update data in the form of data record messages; and
sending approved master database update data in the form of data record messages.

9. An improved database architecture, comprising:
database file means, comprising:
at least one improved database data record, each said improved database data record comprising content data, relationship data and edit history data.

10. The architecture of claim 9, wherein said content data, is identified by metatags.

11. The architecture of claim 10, wherein said relationship data comprises links to other said improved database data records.

12. The architecture of claim 11, wherein each said improved database data record is identified by a unique data record identifier and said relationship data comprises at least one link to a said data record identifier.
